(19) United States
(12) Patent Application Publication
(10) Pub. No.: US 2013/0166322 A1
(43) Pub. Date: Jun. 27, 2013

(54) SYSTEMS AND METHODS FOR COMMUNICATING INFORMATION

(71) Applicant: Aegida Group, LLC, Cincinnati, OH (US)

(72) Inventor: Mark WOODS, Morrow, OH (US)

(73) Assignee: AEGIDA GROUP, LLC, Cincinnati, OH (US)

(21) Appl. No.: 13/724,298

(22) Filed: Dec. 21, 2012

Related U.S. Application Data
(60) Provisional application No. 61/578,279, filed on Dec. 21, 2011.
(60) Provisional application No. 61/622,215, filed on Apr. 10, 2012.

(51) Int. Cl. G06F 19/00; G06Q 50/24

(52) U.S. Cl. CPC G06F 19/322; G06Q 50/24; G06F 19/328
USPC 705/3

(57) ABSTRACT

The present invention provides a method and system for securely collecting, processing, and transmitting information. The system provides the capability for users to input personal, medical, insurance, emergency contacts, and other data important to the user, and securely store and manage that data. The system is linked to other systems to provide those systems user data during an event. The user data is then able to be provided to emergency responders, doctors, or other interested and authorized parties in order to help provide services to the user. One use of the system is for users to input and manage data that is then provide to emergency responders during an accident or event, in order to better care for the user, decrease service costs. The system also allows for querying of user location data.

### RELATED APPLICATIONS

This application claims priority to U.S. Provisional Patent Application No. 61/578,279, filed on Dec. 21, 2011 and U.S. Provisional Patent Application No. 61/622,215, filed on Apr. 10, 2012. Both of the aforementioned patent applications are herein by reference.

### FIELD OF THE INVENTION

The present invention is directed to systems and methods for comprehensive emergency incident management, including storing, retrieving and forwarding medical information to emergency medical systems and networks.

### SUMMARY OF THE INVENTION

The present invention provides a method and system for securely collecting, processing, and transmitting information. The system provides the capability for users to input personal, medical, insurance, emergency contacts, and other data important to the user, and securely store and manage that data. The system is linked to other systems to provide those systems user data during an event. As used herein, the term “event” is defined as a situation or occurrence where user data would be helpful in providing service to a user. The user data thus supplied is then able to be provided to emergency responders, doctors, or other interested and authorized parties in order to help provide services to the user. One use of the system is for users to input and manage data that is then provided to emergency responders during an accident or event, in order to better care for the user, decrease service costs, and ultimately save lives. The system also allows for querying of user location data, uses including but not limited to: search and rescue functions; determining providers for assistance; determining nearest emergency contacts; and providing ancillary services helpful to the user, such as, for example, driving directions.

Multiple points of management are provided for the user to securely input, change, delete and control their data, including kiosks, websites, mobile phone/smart phone applications, or functionality provided by third party systems linked to the invention. Similarly, multiple points of distribution are allowed through an open architecture Auxiliary Programming Interface (API) that allow third party systems to securely query and receive information regarding users during an event. All system functionality conforms to industry standards and best practices, while an open architecture allows for highly flexible and open interfaces to other systems and applications, providing for a wide ability to disseminate information. Information Security standards and best practices are employed to safeguard user data from intentional, unintentional malicious, or benign interception or access by unauthorized parties.

### DESCRIPTION OF THE DRAWINGS

FIG. 1 is a flow chart showing the system download, registration and subscription process.

FIG. 2 is a flow chart showing the device activation process.

FIG. 3 is a flow chart showing the new user profile process.

FIG. 4 is a flow chart showing the profile editing process.

FIG. 5 is a flow chart showing the application synchronization process.

FIG. 6 is a flow chart showing the information retrieval and viewing process.

FIG. 7 is a flow chart showing the system call for assistance process.

### DETAILED DESCRIPTION OF PREFERRED AND ALTERNATE EMBODIMENTS

The present invention provides a method and system for securely collecting, processing and transmitting information. The system allows for users to input their personal, medical, insurance, emergency contacts, and other data important to the user, and securely store and manage that data. The system is linked to other systems and organizations, such as call centers and 911 dispatch systems, in order to automatically provide relevant information about a user that is involved in an incident or event. Information provided includes data input by the user and specified as transmittable or transferrable to other systems or organizations. Information provided potentially includes, for example, location and personal data helpful in locating an individual during a request for assistance or service.

Information security standards and best practices are employed to safeguard user data from intentional, unintentional malicious or benign interception or access by unauthorized parties. A preferred embodiment of the system provides an integrated personal information system collecting, processing and transmitting personal, medical, insurance, emergency contacts, and location data. The system allows users to personally input and manage their data, making it available to other organizations or systems as their assistance need may arise. Such personal data includes, but is not limited to: name; address; telephone numbers; current location; age; sex; height; weight; blood type; email address; and photos. Medical data includes but is not limited to: living will status; organ donor status; previous medical conditions; current medical conditions; medications taken; doses of said medication; frequency of doses of said medications; drug allergies; medical devices in use; manufacturer of said medical devices; models of said medical devices; surgical history; other allergies; immunization history; medical images; legal documents; religious restrictions and objections; dietary restrictions; and notes. Emergency contact information includes, but is not limited to: contact type; relationship; name; address; telephone numbers; and email addresses. Insurance information includes but is not limited to: insurance company, insurance type, policy group number; policy group type; policy number; effective date; name of insured; relationship to insured; benefits available; and co-pays required. Location data includes, but is not limited to: automatically generated or manually input geocoded or longitude and latitude, or other location formats. Alternative embodiments of the system can be used to collect, process and transmit other types of data. For example, the system can be used to collect, process, and transmit other vital information such as bank account information, passwords, or any other type of data that a user may wish to input, manage, and potentially make available to others.

The system is comprised of one or more computing devices, consisting of memory, one or more processors, long term data storage devices, network capability, and other facets commonly employed in generic computing devices. The system is programmed such that the computing device provides multiple interfaces to the user. Multiple computing devices may be employed by the system through linking them via communications facilities such as Ethernet, TCP/IP, data carrier lines, or other available communications facilities or networks. Server devices may be located in the same geographic location, may be distributed across multiple locations, may be of a virtualized nature. Cloud environments may be employed to provide computing platforms utilized by the system. Some examples of cloud environments include infrastructure cloud environments which provide abstracted hardware for running the system's operating system and software, or software cloud environments that run the system's software directly. User access to the system may be provided through multiple means, mobile device applications, desktop applications, and websites.

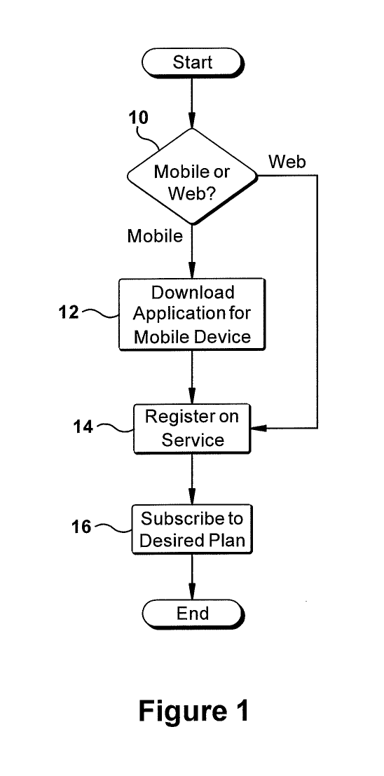

Connectivity to the system may be provided by communications networks, including but not limited to: the Internet; inter- and intra-nets, or other available communications facilities. FIG. 1 contains a diagram of how a user may access the system. In a preferred embodiment, a user may access the system via a mobile device or a website 10. Other access means may be provided, for example, a desktop application. Access via a mobile device allows the user to download a mobile application to the device 12. A user might also access the system via a mobile device without having to download and run a mobile app by using the web browser capabilities of the device. Once access is provided, a user registers on the system 14 and the system processes the user's registration and stores that information for later retrieval. Additionally, a user may subscribe to a service plan 16, though a subscription may not be required for service. To subscribe the user enters subscription and payment information, selecting items such as subscription term or length and entering payment information. The system then may enable the subscription by authorizing the payment information.

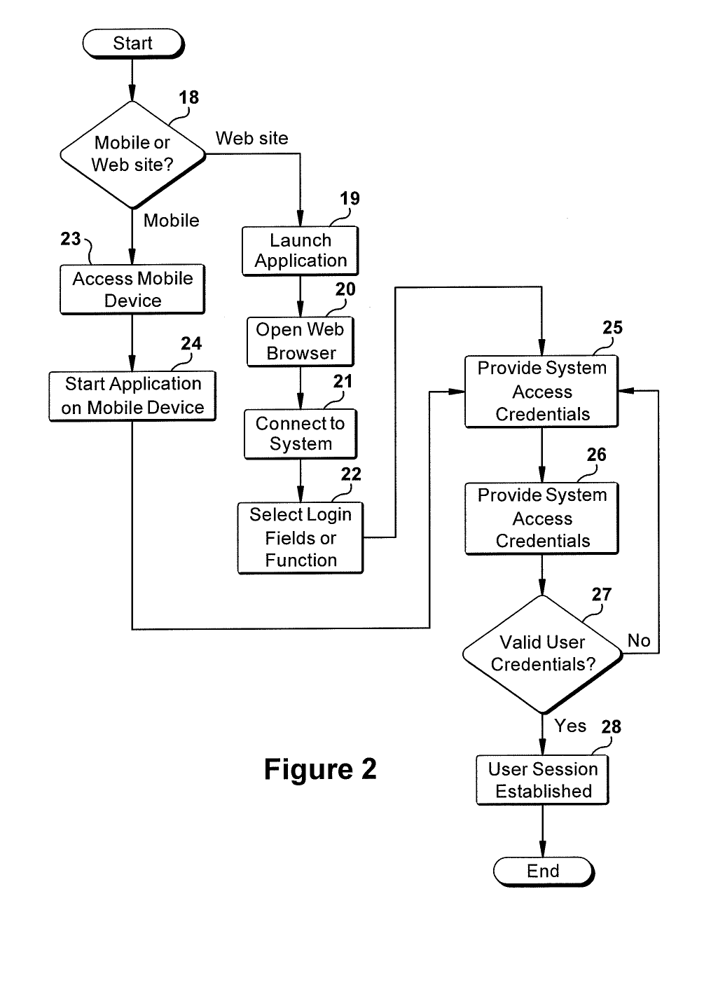

Once a user device is registered and potentially subscribed, the system may then generate authentication information by processing the user's data and generating an activation code for the user's mobile application. The system then returns the activation code to the user by sending it to the user through, for example, email, or displaying it in their system for the user to see. The user then inputs the activation code to link the user's downloaded application, linking it to their account on the system. Other authentication information may be generated, for example, a username or password, that allows the user to access the service via means such as a website. FIG. 2 is a diagram of how a user may be authenticated while establishing a connection to the system. In a preferred embodiment, the user will access the system via a web browser or mobile device application 18. If the user is using a web browser, he/she will launch the application 19, open a web browser 20, connect to the system 21, and select login fields or function 22. If the user is using a mobile device application, he/she will access the mobile device 23 and start the application on the mobile device 24. In another embodiment, access may include integration with third party systems in which case the user may connect to a third party system as that system provides and access their information seamlessly via functions provided in the system. Once connected to the system, the user would be presented with a request for system access credentials 25, which are then provided by the user 26. Upon successful validation of the user's access credentials 27, a session is established 28 with the system and the user is granted access to provided system functions. In a preferred embodiment, users access the invention system via a web browser or mobile device application. Other embodiments allow access via other user systems, for example, desktops, laptops, tablets, kiosks, appliances, or other general purpose personal computing hardware or systems. In a preferred embodiment, connection to the system is via protocols such as Internet Protocol (IP), Hypertext Transfer Protocol (HTTP), Secure Sockets Layer (SSL), or SSL/Transport Layer Security (SSL/TSL), also known as Secure Hypertext Transfer Protocol (HTTPS). Other embodiments may use other widespread protocols and functions in modern use. In a preferred embodiment, system access credentials provide single or multi-factor authentication, and include usernames, passwords, user certificates, hardware or software tokens. Other embodiments may provide authentication via other methods of secure authentication including electronic or biometric capabilities, or other industry standard login processing controls.

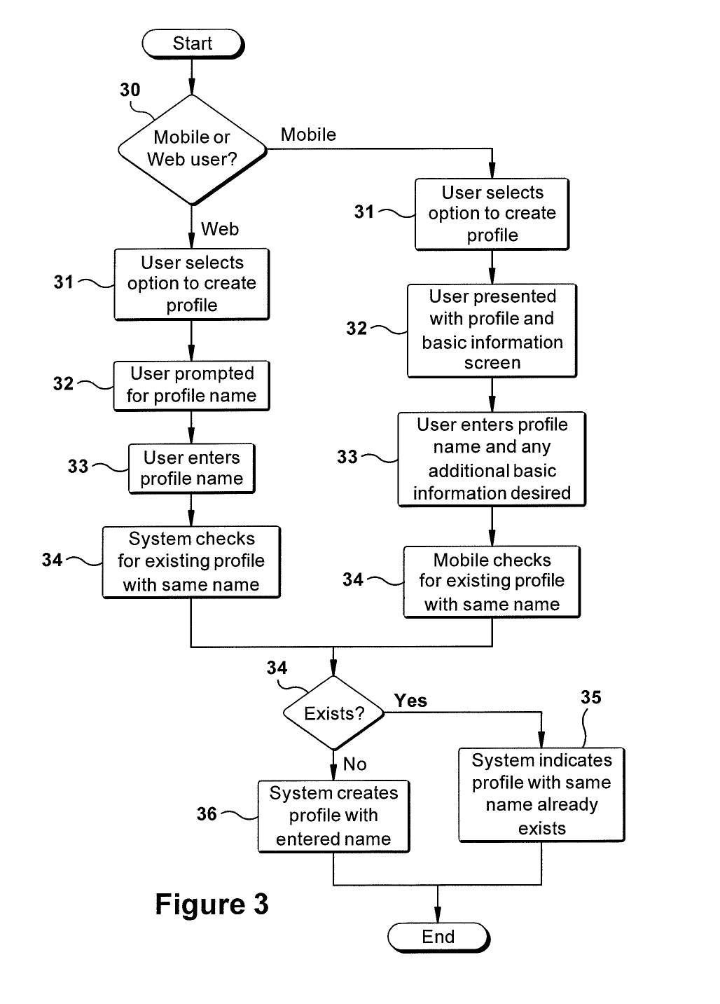

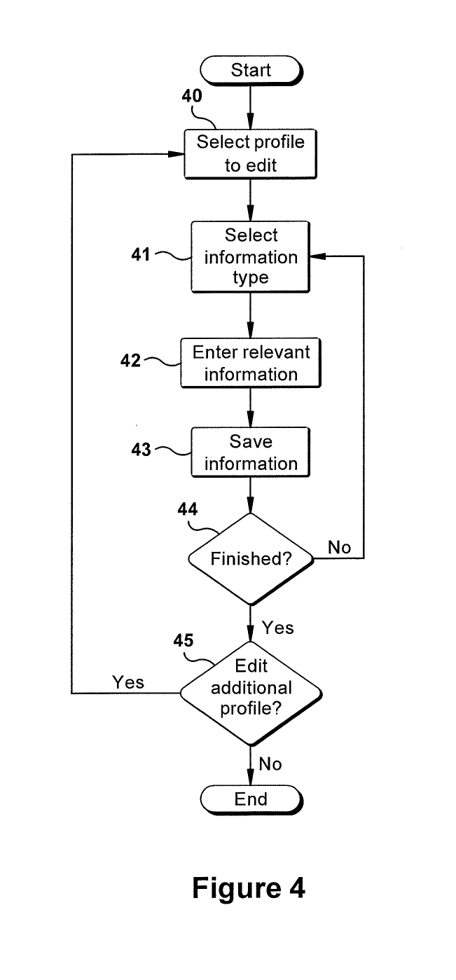

Once authenticated, the system provides functions related to account management, profile creation and management, and subscription management, among other functions. FIG. 3 contains a diagram of how a user may create a profile to store information. Profiles may be singular or grouped together through factors. In a preferred embodiment, profiles are grouped via subscription. Alternate embodiments may use other factors to group users, for example, work organizations, volunteer organizations affiliation, or family relationships. Again, the user will access the system via a web browser or mobile device application 30. In a preferred embodiment, the user selects an option to create a profile 31 and is prompted to input a name for the profile 32. Once the user enters a profile name 33, the system then checks to ensure that a profile with that same name does not already exist 34, requiring the user to input a different name if it does already exist 35 or creating the profile if it does not exist 36. Alternate embodiments may use a different method of generating an identifier for a profile, for example automatically creating a profile identifier using data available to or generated by the system. FIG. 4 contains a diagram of how a user manages information in a profile. In a preferred embodiment, the system displays multiple available profiles to the user for selection and the user selects a profile to edit 40. Alternate embodiments may only display a single profile to the user, for example in a single user subscription. Once a profile is selected, the user is presented with categories of information to select for editing, which categories are discussed above. Once a category is selected 41, relevant information is entered, deleted, or changed as desired 42. In a preferred embodiment, the system has functions available for the user that allow control over security of the data. For example, the user may be able to select if the information is viewable by other users that share the same subscription or if the user is transmittable or displayable to emergency responders. Other embodiments may extend these security capabilities, for example to allow other users in different subscriptions to see the information, or to allow management personnel in the user's organization to see the user's information, or to specify times, such as day, date, and time, that the information may be viewed. This functionality allows the user tight, granular control over who is able to see their information and when that information is available. In a preferred embodiment, once management of the information is completed, the user selects an option to save the changes which causes the system to save the information 43 and potentially present additional categories of information to manage. Alternate embodiments may automatically save the data when modified. It is then determined whether the editing is complete 44. If editing is completed, the system may prompt or provide functions that allow the user to manage data in additional profiles that may be available to the user 45.

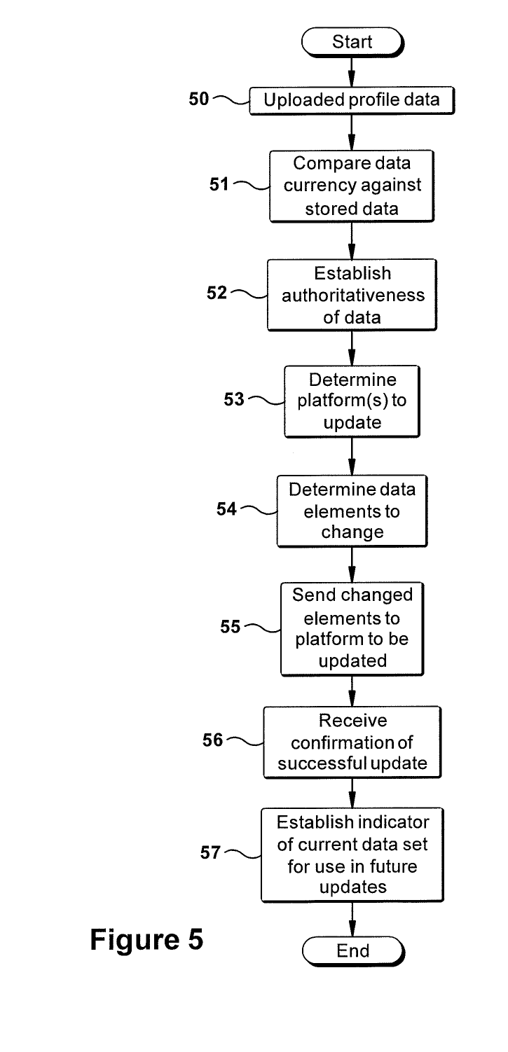

FIG. 5 is a diagram of the system's data synchronization function. In a preferred embodiment, the user may input data through multiple means, for example via the system web site and also via a mobile phone app. This may cause different data sets to exist in both environments, as the mobile phone app may contain both the ability to manage the user's data and means to store that data locally. Thus, a synchronization function is needed in order to ensure that data does not differ and only authoritative data exists. Once the user has managed their data, causing it to potentially change on one or more access points or devices, the user may select to have the data synchronized across the affected devices or access points. In an alternate embodiment, this function may not need to be presented to the user, for example with automatic synchronization functionality. The synchronization function must first obtain the different sets of data to synchronize, for example by the mobile device app uploading the data to the system 50. The system then can compare the uploaded data to the data stored in the system, and determine which data sets or individual data items are authoritative 51. After determining what data is authoritative 52, the system then determines the platforms 53 to updated data elements to change in those platforms 54, and sends the changed data elements to the platform to be updated 55. After the platforms receive the updated data and successfully update their individual data stores, they may send a confirmation of successful update to the system 56, which then may display an indicator of the success. The system may also establish data points useful in assisting with further updates, for example update version numbers 57.

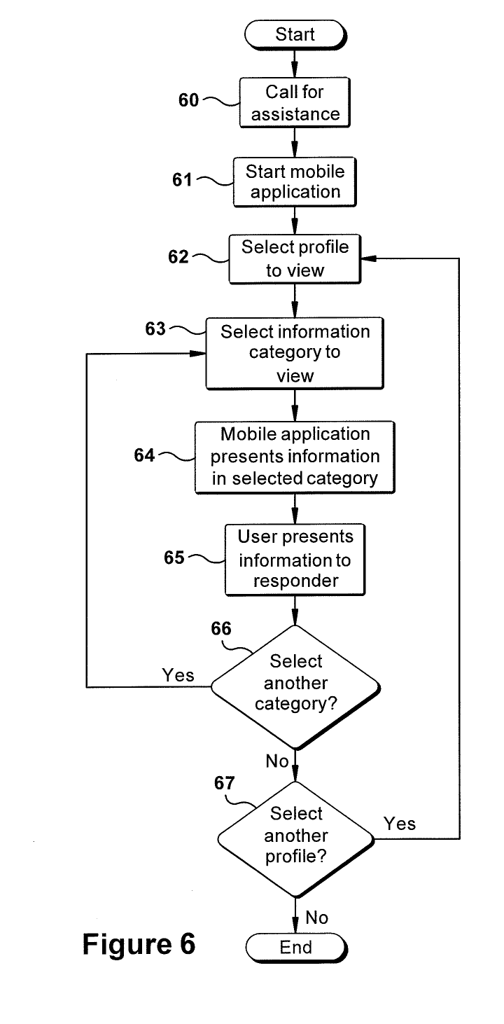

FIG. 6 contains a diagram of how a user may present their data to another individual. As mentioned above, the system is intended to not only allow users to input and manage their data, but also to present this data to interested parties that might be of service or assistance to them. The system contains data input by the user that is personal and potentially vital when the user needs assistance, for example, current medical information. The presentation function outlined in FIG. 6 requires the user to access the system or call for assistance 60. In a preferred embodiment, this would be by accessing the web site or by starting the mobile app 61. Alternate embodiments might allow for other points of access, for example, by connecting to and logging into a third party system linked to the present invention. Once the user has connected to the system and authenticated, the user would potentially select the profile to view 62. The user may not have to select a profile however, for example if only one profile is available to the user based on the user's rights in the system. Once the profile is selected, the user may select 63 and view 64 on or more categories of information with one or more data sets of information contained within each category. The user may then present the desired information sets to the individual or organization assisting the user in order to assist that individual or organization in providing service to the user 65. Likewise, the user is able to present the information available to the user to any individual or organization, as that user desires for any purpose the user desires. The user may then select another category to view 66. If the user does not need to select another category they may choose to select another profile for viewing 67. Once the user no longer needs to display their information, they may disconnect from the service or close their mobile application to terminate their session. The user may also choose to keep their session active so that they can make additional actions in the future.

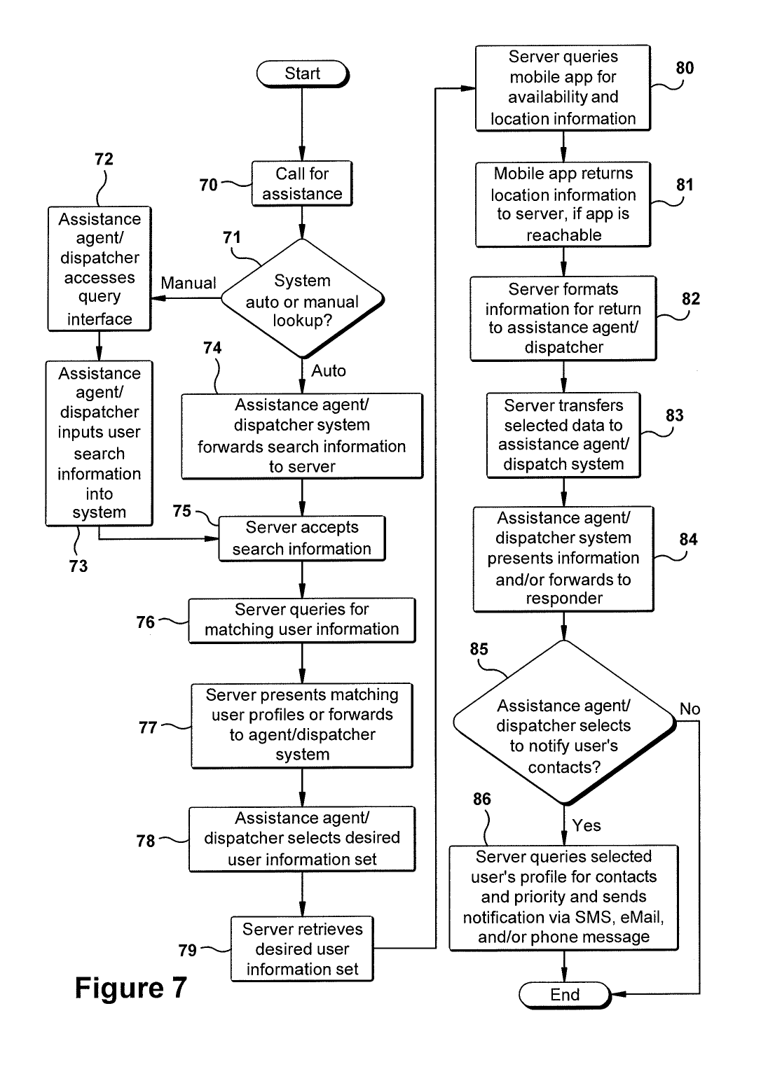

FIG. 7 is a diagram of how a third party may query the system in order to obtain user data. In the preferred embodiment, the user will not have to present this data themselves, which allows a servicing organization to obtain information that will be helpful in servicing the user absent a user action. For example, a user might be incapacitated in an accident and not able to display their information themselves, in which scenario a first responder or Public Safety Access Point might access the system independent of the user's action 70 in order to obtain critical medical information about that user. In a preferred embodiment, an individual or organization needing independent access to a user's data would have a consistent connection to the system that allows queries to be performed. Alternate embodiments may not require a consistent connection, in which case the individual or organization would first have to connect to the system. In a preferred embodiment, the individual or organization needing access to a user's data will be connected through a system that they use, and upon a request for service their system will automatically query the system for data. In alternate embodiments, an individual or organization may need to perform a manual lookup, for example, when their system is not interconnected to the system. Queries may be performed, either automatically or manually 71, using any of the points of data available in the system. If the query is performed manually an assistance agent/dispatcher must first access the query interface 72 and then input the user search information into the system 73. If the query is an automatic lookup, then the assistance agent/dispatcher system forwards search information to the server 74. Upon issuance of a query (either manually or automatically) , the system then may validate and accept the query 75 and search the data sets stored in the system for matching user information 76. Matching user information can then be grouped together using one or more grouping elements, and presented to the querying individual or system 77. Said individual or system may then examine the potentially grouped data, selecting which elements of data are of interest for viewing 78. Multiple iterations of querying may be necessary to obtain the desired data, and once the desired information set is finally selected it is retrieved by the system for display to the querying individual, organization or system desires 79.

In a preferred embodiment, the system provides functionality to allow the querying individual or organization, for example a dispatcher or PSAP, to automatically send a notification to one or more contacts provided by the user. Such functionality includes email, SMS, and telephone and may include information that the user was involved in an incident, requests assistance, or any other message desired. Additionally, the system provides two-way messaging functionality, allowing the receipt of response messages from the messaged individuals and enabling full communications with that individual. Alternate embodiments may include manually sending notifications where automated notifications are not available, and may also include other communications channels as may be in common use. The server must query the mobile app for availability and for location information 80. The mobile app, if available, returns location information to the server 81. The server formats the information when returning the data to the assistance agent/dispatcher 82. The server transfers the selected data to the assistance agent/dispatch system 83. The assistance agent/dispatch system presents the information and/or forwards the information to the responder 84. The assistance agent/dispatcher may select to notify the user's contacts 85. If this option is selected, the server queries the selected user's profile for contacts and priority and sends notification via SMS, email, and/or telephone 86.

In a preferred embodiment, records of all system processing activities, data queries, and information dissemination are stored in the system, allowing for presentation of this information in an audit trail and notification to the user that their data was accessed along with metadata about the access. Alternate embodiments may use the system processing activities, data queries, and information dissemination in differing ways, for example to improve system security, improve system performance, or provide statistics about data contained in the system and its use.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A system for communicating information comprising:
one or more centralized servers linked via one or more communications networks to a personal or mobile user information management device;
at least one user profile containing user's personal, medical and insurance information, the at least one user profile saved to the one or more centralized servers;
wherein the system allows user access to the user's personal, medical and insurance information contained in the at least one user profile; and
wherein the system provides access to the user's personal, medical, and insurance information and user-location data to 911 dispatch systems, emergency responders, doctors or other authorized parties.

2. The system of claim 1, wherein the user's personal information in the at least one user profile includes one or more of the following: user name, user address, user telephone number, user age, user sex, user height, user weight, user blood type, user email address and user photo.

3. The system of claim 1, wherein the user's medical information in the at least one user profile includes one or more of the following: user will status, organ donor status, previous medical conditions, current medical conditions, medications, medication doses, medication frequency, allergies, surgical history, immunization history, medical images, and dietary restrictions.

4. The system of claim 1, wherein the user's insurance information in the at least one user profile includes one or more of the following: insurance company, insurance type, insurance policy number, insurance group type, effective date of insurance, name of insured, user's relationship to the insured, benefits available, and required co-pay.

5. The system of claim 1, wherein the at least one user profile additionally contains emergency contact information.

6. The system of claim 1, wherein the system is able to determine real-time user location information.

7. A system for communicating information comprising:
one or more computer servers comprising memory, one or more processors, long term data storage devices, network connection capabilities, and software;
a mobile software application operative to be downloaded to a compatible user device;
a plurality of user profiles saved on the one or more computer servers, each of the plurality of user profiles comprising personal information, medical information, and insurance information for a particular user;
wherein the system enables users to access and manipulate their user profile; and
wherein the system enables access to user profiles by 911 dispatch services, emergency medical responders, doctors or other user-authorized parties.

8. The system of claim 7, wherein the system is operative to provide access to real-time user location data.

9. The system of claim 7, wherein the system is operative to synchronize data between the compatible user device and the one or more computer servers.

10. The system of claim 7, wherein user's may view their user profile via the mobile software application.
